(19) United States
(12) Patent Application Publication
(10) Pub. No.: US 2012/0228404 A1
(43) Pub. Date: Sep. 13, 2012

(54) SYSTEMS AND METHODS FOR DELIVERING A LIQUID HAVING A DESIRED DISSOLVED GAS CONCENTRATION

(75) Inventor: Grace Richardson, Fayetteville, AR (US)

(73) Assignee: BluelnGreen LLC

(21) Appl. No.: 13/414,239

(22) Filed: Mar. 7, 2012

Related U.S. Application Data
(60) Provisional application No. 61/450,459, filed on Mar. 8, 2011.

(51) Int. Cl. B05B 7/00

(52) U.S. Cl. 239/337

(57) ABSTRACT

Systems and methods for delivering a fluid having a desired dissolved gas concentration are provided. The system includes a dissolution tank having a pressure vessel, a gas source in communication with the pressure vessel, a pump for supplying fluid to a spray nozzle of the dissolution tank, a sensor for detecting fluid levels in an internal chamber of the pressure vessel, and a controller for adjusting fluid levels in the pressure vessel. The method includes supplying fluid to the spray nozzle of the dissolution tank such that fluid droplets are formed in a gas head space of the dissolution tank and gas contained within the head space is dissolved into the fluid. The method can also include spraying a first portion of the liquid containing dissolved gas through a plurality of chamber orifices into a second portion of the liquid.

### CROSS-REFERENCE TO RELATED APPLICATIONS

This application claims the benefit of U.S. Provisional Application 61/450,459 filed on Mar. 8, 2011. In addition, U.S. Provisional Application 61/450,459 is related to currently pending U.S. application Ser. No. 11/921,057, filed Nov. 7, 2008, entitled SYSTEM AND METHOD FOR DISSOLVING GASES IN FLUIDS AND FOR DELIVERY OF DISSOLVED GASES and to U.S. Pat. No. 7,255,332, issued on Aug. 14, 2007, the disclosures of which are incorporated herein by reference.

### STATEMENT REGARDING FEDERALLY SPONSORED RESEARCH OR DEVELOPMENT

The present invention has been supported at least in part by the National Science Foundation SBIR Program, Grant No. IIP-0750402DM1-041955. The Government has certain rights to the invention.

### BACKGROUND OF THE INVENTION

1. Field of the Invention

The subject invention is directed to systems and methods for delivering a liquid having a desired dissolved gas concentration at a substantially constant flow rate, and more particularly, to systems and methods for controlling the delivery rate of a dissolved gas by varying the level of a liquid within a dissolution tank.

2. Background of the Invention

Many different systems and methods, depending on application, are available for dissolving gases in liquids. Some of the main applications are the oxygenation of outdoor water bodies, industrial uses, and the treatment of wastewater. Most dissolved gas delivery methods (i.e. bubble diffusion, Venturi injection, U-tubes, Speece cones) are based on increasing the contact time and/or surface area of gas bubbles introduced into a bulk liquid to enhance mass transfer. Previous technologies for dissolving gas into a liquid have features that increase the contact time and/or contact area between gas bubbles and bulk fluid to increase dissolution. Most, if not all, of these earlier technologies require recovery systems for off-gases that do not dissolve into the fluid or allow loss of undissolved gases.

U.S. Pat. No. 5,979,363 (issued to Shaar) describes an aquaculture system that involves piping a food and oxygen slurry into a pond. U.S. Pat. No. 5,911,870 (issued to Hough) proposes a device for increasing the quantity of dissolved oxygen in water and employs an electrolytic cell to generate the oxygen. U.S. Pat. No. 5,904,851 (issued to Taylor et al.) proposes a method for enriching water with oxygen that employs a Venturi-type injector to aspirate gas into a fluid, followed by mixing to increase dissolution. U.S. Pat. No. 5,885,467 (issued to Zelenak et al.) proposes mixing a liquid with oxygen using a plurality of plates or trays over which the liquid flows gradually downward. U.S. Pat. No. 4,501,664 (issued to Heil et al.) proposes a device for treating organic wastewater with dissolved oxygen that employs several process compartments. U.S. Pat. No. 5,766,484 (issued to Petit et al.) proposes a dissolved gas flotation system for treatment of wastewater wherein the relative location of inlet and outlet structures reportedly maximizes the effect of air bubbles in separating solids from the fluid. U.S. Pat. No. 5,647,977 (issued to Arnaud) proposes a system for treating wastewater that includes aeration, mixing/flocculating, and contact media for removing suspended solids, etc. U.S. Pat. No. 5,382,358 (issued to Yeh) proposes an apparatus for separation of suspended matter in a liquid by dissolved air flotation (DAF). U.S. Pat. No. 3,932,282 (issued to Ettelt) proposes a dissolved air flotation system that includes a vertical flotation column designed with an aim of preventing bubble breakage.

Mazzei injectors (see, e.g., U.S. Pat. Nos. 5,674,312; 6,193,893; 6,730,214) use a rapid flow of water to draw gas into the fluid stream; mixing chambers may or may not be used to increase contact time between the gas bubbles and the fluid to increase dissolution. The method of Keirn (U.S. Pat. No. 6,530,895) has a series of chambers under pressure that add gaseous oxygen to fluid; the pressure increase and the chambers in series are used to increase dissolution. U.S. Pat. No. 6,962,654 (issued to Arnaud) uses a radially grooved ring to break a stream of fluid into smaller streams; gas is introduced into the streams and mixing is used to increase dissolution. Speece (see U.S. Pat. Nos. 3,643,403; 6,474,627; 6,485,003; 6,848,258) proposes use of head pressure to introduce liquid under pressure into a conical chamber; the downward flow of the fluid is matched in velocity to the upward flow of gas bubbles to increase dissolution time. Littman et al. (U.S. Pat. No. 6,279,882) uses similar technology to Speece except that the upward flowing bubble size is decreased with a Shockwave. Roberts, Jr. et al. (U.S. Pat. No. 4,317,731) propose turbulent mixing in an upper chamber to mix gas with a bulk fluid; a quiescent lower chamber allows undissolved gas to rise back into the upper chamber for remixing. The following U.S. patents use various methods to increase the contact time between gas bubbles in fluids: U.S. Pat. Nos. 5,275,742 (Satchell Jr. et al.); 5,451,349 (Kingsley); 5,865,995 (Nelson); 6,076,808 (Porter); 6,090,294 (Teran et al.); 6,503,403 (Green et al.); 6,840,983 (McNulty). Spears, et al (U.S. Pat. Nos. 7,294,278; 7,008,535) describe a method for varying the dissolved gas concentration of liquid by varying the pressure from 14.7 to 3000 psi inside an oxygenation assembly. Patterson, et al (U.S. Pat. No. 6,565,807) describe a method for maintaining, adjusting, or otherwise controlling the levels of oxygen dissolved in blood (e.g., pO₂) by controlling the flow rates or by providing controlled amounts of the blood and/or oxygen gas.

For the most part, the above-described methods and systems are either expensive to manufacture, are relatively large, inefficiently dissolve the gas in the fluid, and/or are costly to operate. Moreover, in applications, such as wastewater treatment, wherein the quantity and loading (e.g., amount of solids) of the wastewater vary over time, there is a need to be able to vary the dissolved gas levels (e.g., oxygen, ozone) in the wastewater or carrier fluid without impacting the volume of the wastewater being treated.

Therefore, there is a need for a simplified, low cost, and precise system and method for controlling the dissolved gas levels in a liquid and preferably a system and method which is also capable of maintain the flow rate of the liquid through the system constant.

### BRIEF SUMMARY OF THE INVENTION

The present invention is directed to simple and economical systems and methods for controlling the dissolution of one or more gases into a liquid, such as water, while maintaining a constant flow of the liquid into and out of the system. Preferred gases for use with the disclosed systems and methods are oxygen, air, ozone, and carbon dioxide. Preferred applications include, for example, oxygenation and/or ozonation treatment of rivers, streams, lakes, ponds, and basins in natural, municipal, or industrial settings and wastewater treatment.

More specifically, the present invention is directed to systems for delivering a fluid having a desired dissolved gas concentration that include, inter alia, a dissolution tank assembly that has a pressure vessel which defines an internal chamber for containing a fluid and provides a regulated, pressurized gas head space above the fluid. The dissolution tank also includes at least one liquid spray nozzle that permits passage of the fluid into the gas head space of the pressure vessel; and an outlet for discharging the fluid having a desired gas concentration from the pressure vessel. The systems of the present invention further include a gas source in communication with the gas head space of the pressure vessel and a pumping mechanism (mechanical or non-mechanical) for supplying the fluid to the spray nozzle of the dissolution tank, such that fluid droplets are formed and the gas contained within the pressurized head space is dissolved into the fluid. Also provided is a device for detecting the level of the fluid in the internal chamber of the pressure vessel and a mechanism for adjusting the level of fluid in the pressure vessel in order to achieve the desired dissolved gas concentration within the fluid.

Preferably, the mechanism for detecting the level of the fluid in the tank includes a liquid level gauge. It is also envisioned that the systems of the present invention can further include: a sensor for measuring the concentration of the gas within the fluid being discharged from the pressure vessel and/or a pump for discharging the fluid from the pressure vessel through the outlet at a constant flow rate.

The present invention is also directed to a method for delivering or providing a fluid having a desired dissolved gas concentration. The method includes the step of providing a dissolution tank assembly that has (i) a pressure vessel defining an internal chamber for containing a fluid and providing a regulated, pressurized gas head space above the fluid; (ii) at least one liquid spray nozzle that permits passage of the fluid into the gas head space of the pressure vessel; and (iii) an outlet for discharging the fluid having a desired gas concentration from the pressure vessel. A gas source is provided in communication with the gas head space of the pressure vessel. Fluid is supplied using a pumping mechanism to the spray nozzle of the dissolution tank such that fluid droplets are formed and the gas contained within the pressurized head space is dissolved into the fluid. Moreover, the level of the fluid in the internal chamber of the pressure vessel is detected by a level gauge or the like and the level of fluid in the pressure vessel is adjusted in order to achieve the desired dissolved gas concentration within the fluid.

By varying the liquid level in the enclosed pressure vessel, the surface area of the liquid exposed to the gas in the vessel is either increased or decreased, thereby regulating the percentage of the gas that is able to dissolve into the liquid which preferably flows through the pressure vessel at a constant flow rate.

Methods for dissolving a gas in a liquid that involve pressurizing an enclosed pressure vessel with the gas and spraying the liquid into the vessel that contains the gas have been previously described in U.S. application Ser. No. 11/921,057, filed Nov. 7, 2008 and in U.S. Pat. No. 7,255,332, issued on Aug. 14, 2007, the disclosures of which are incorporated herein by reference. Disclosed herein are systems and methods for controlling the dissolution efficiency of the gas in the systems described in the aforementioned patent application and patent.

These and other features and benefits of the subject invention and the manner in which it is assembled and employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the systems and methods of the subject invention without undue experimentation, preferred embodiments thereof will be described in detail hereinbelow with reference to certain figures, wherein:

FIG. 1 shows a schematic diagram illustrating an embodiment of the present invention being used for treatment of a natural stream;

FIGS. 2a through 2c each provide a cross-sectional view of a dissolution tank of the present invention having varying liquid levels and gas head space;

FIG. 3 is a graphical representation showing the concentration of dissolved oxygen in a membrane bioreactor basin over time with and without use of the level control method of the present invention; and

FIG. 4 is a graphical representation showing the varying flow rate into the membrane bioreactor basin of FIG. 3.

These and other aspects of the subject invention will become more readily apparent to those having ordinary skill in the art from the following detailed description of the invention taken in conjunction with the drawings.

### DETAILED DESCRIPTION OF THE INVENTION

Disclosed herein are detailed descriptions of specific embodiments of the systems and methods of the present invention for delivering a liquid having a desired dissolved gas concentration and preferably for delivering the liquid at a constant flow rate. It will be understood that the disclosed embodiments are merely examples of ways in which certain aspects of the invention can be implemented and do not represent an exhaustive list of all of the ways the invention may be embodied. Indeed, it will be understood that the systems, devices, and methods described herein may be embodied in various and alternative forms. The figures are not necessarily to scale and some features may be exaggerated or minimized to show details of particular components. Well-known components, materials or methods are not necessarily described in great detail in order to avoid obscuring the present disclosure.

Figures illustrating the components show some elements that are known and will be recognized by one skilled in the art. The detailed descriptions of such elements are not necessary to an understanding of the invention, and accordingly, are herein presented only to the degree necessary to facilitate an understanding of the novel features of the present invention.

A method is disclosed herein that allows an operator to manipulate the liquid level within an enclosed vessel, so that the gas transfer efficiency within the vessel can be increased or decreased and thereby allowing the operator to regulate the control of dissolution of a gas into the liquid that is flowing through a pressurized, enclosed vessel while providing the ability to maintain a constant flow rate of the liquid from the vessel. This is particularly, but not exclusively, advantageous when the vessel is in-line with any flow-through process such as a membrane bioreactor, a wastewater treatment system, a drinking water treatment system, or ecological remediation system, and is serving the dual purpose of both liquid flow rate control and dissolved gas delivery device. This allows an operator to limit the amount of gas dissolved in the liquid in situations when excess dissolved gas is not necessary, but the flow rate of liquid through the vessel must remain constant.

As will be described herein below, the method used to increase gas transfer efficiency within the vessel includes a nozzle that disperses a first portion of liquid, which is passed through the vessel, into very small particles, thereby increasing the surface area of the liquid and maximizing gas transfer into the liquid droplets. As the liquid level in the vessel increases, the time that the liquid particles remain suspended in gas decreases, thereby decreasing the amount of time in which gas transfer occurs. The liquid level can be raised up to a point where the nozzle is completely submersed in the liquid, thereby reducing the surface area of the liquid to only the cross sectional area of the vessel. This severely limits the amount of gas that is transferred to the liquid. When it is desired to provide the liquid with higher levels of dissolved gas, the liquid level in the enclosed vessel may be lowered again to a point where the gas transfer efficiency is increased by increasing the surface area of the liquid being exposed to the gas, in the form of small liquid particles.

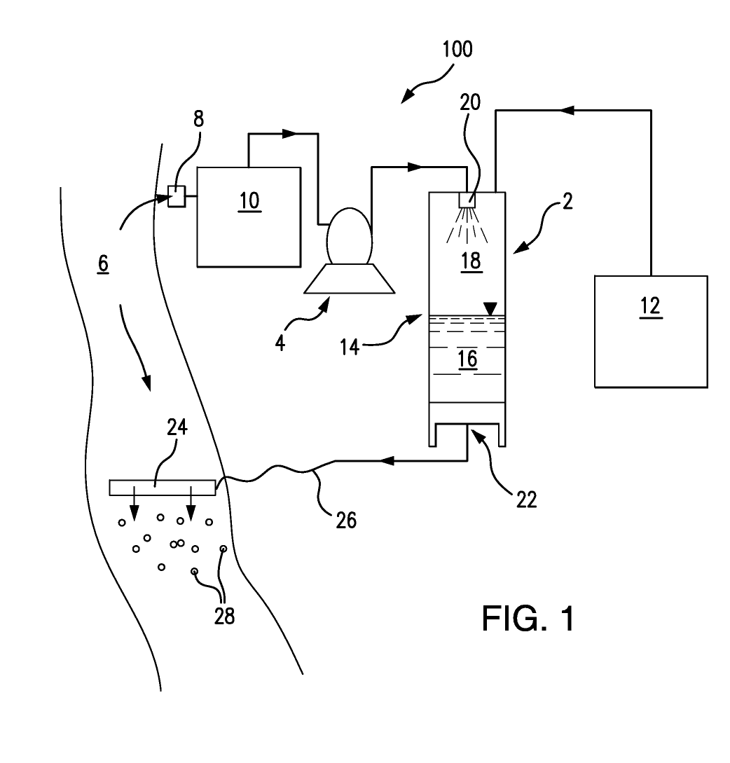

Referring now to FIG. 1, which illustrates a system for dissolving gases in a fluid which has been constructed in accordance with an embodiment of the present invention and has been designated as reference number 100. System 100 is similar in basic structure to the system disclosed in U.S. application Ser. No. 11/621,057, but includes additional mechanism, sensors and controls which allow the liquid level within the tank to be adjusted, so as to be able to regulate the gas transfer efficiency of the system while maintaining, if desired, a constant flow rate of the fluid.

Gas dissolution system 100 includes, inter alia, a dissolution tank 2 and fluid pumping means 4 in fluid communication with the dissolution tank 2. The pumping means 4 receives a source fluid from, for example, stream 6 via filter 8 and supply tank 10. In wastewater treatment applications, the source of fluid could be the raw wastewater.

A source 12 of gas is in communication with the dissolution tank 2. Dissolution tank 2 preferably includes a pressure vessel 14 that defines an internal chamber which contains the fluid 16 and provides a gas head space 18 above the fluid at preferably a super-atmospheric pressure. The dissolution tank 2 also includes at least one liquid spray nozzle 20 that permits passage of source fluid into the pressure vessel 14 through action of pumping means 4. The dissolution tank also comprises an outlet 22 in the tank that permits passage of gasified fluid into discharge device 24, through connecting means 26. In the example shown in FIG. 1, the gasified fluid is discharged into stream 6 by passing through at least one orifice(s) provided in the wall of the discharge device (not shown). Due to the difference in pressure between the pressurized fluid being discharged from system 100 and the stream 6, dissolved gas 28 is thereby released into the stream. The gas is preferably, but not limited to, air, oxygen, ozone, hydrogen, nitrogen, nitrous oxide, or carbon dioxide, and the liquid is typically composed primarily of water.

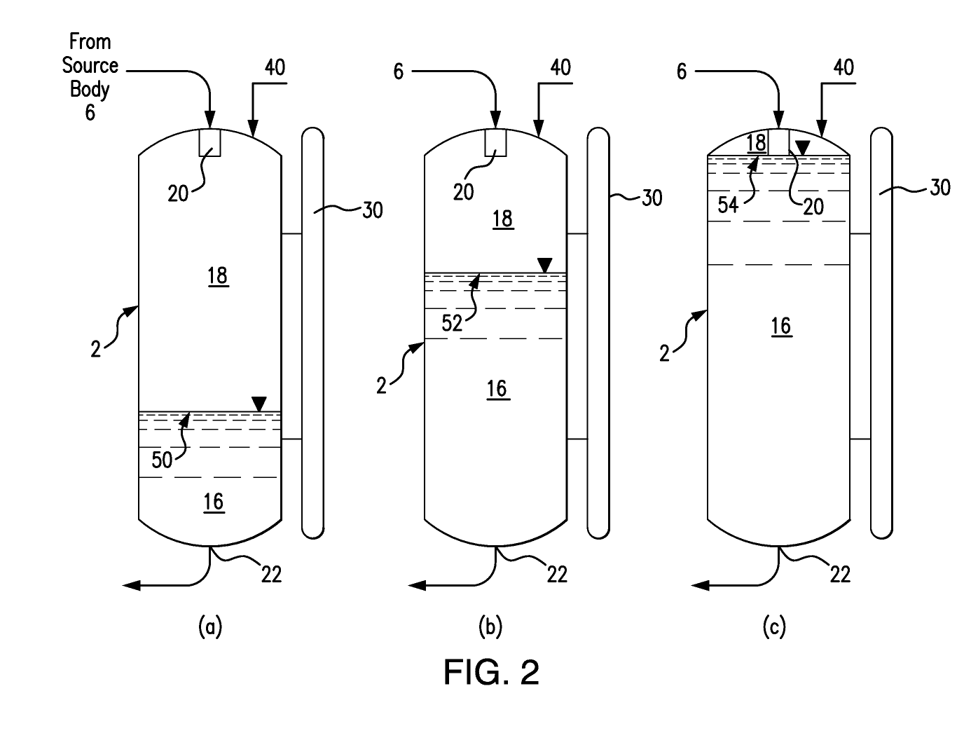

Referring now to FIGS. 2a through 2c, which illustrate a method for controlling the dissolved gas delivery rate of system 100 using fluid level control. Each of the figures provides a cross-sectional view of dissolution tank 100 of the present invention having varying liquid levels and gas head space.

As shown in FIGS. 2a-c, the method of the present invention includes controlling the level of the liquid 16 in the dissolution tank in order to change the volume of the gaseous headspace 18 in the dissolution tank 2. In the system of the present invention, liquid 16 is transferred by pumping means 4 from the source body through at least one nozzle 20 and into dissolution tank 2. A pressurized gas 40 is also supplied into the gas head space 18 of dissolution tank 2. The fluid level within the tank is detected by, for example, a liquid level gauge 7. Preferably, the liquid level reading is transmitted to controls or a control system which can be comprised of a programmable logic controller or other logic and/or relay programming. The control system can be used to automatically adjust the liquid level within the tank based on the sensed liquid level and the desired dissolution rate for the gas. Those skilled in the art will readily appreciate that other means for sensing the level of the liquid within the tank can be used without departing from the scope of the present invention. Moreover, the liquid level can be adjusted manually and without the aid of a control system.

Liquid containing the desired amount of dissolved gas is then discharged through outlet 22 in the dissolution tank 2 as described with respect to FIG. 1. The liquid level within the dissolution tank 2 can be set at varying levels in order to adjust the gas transfer efficiency into the liquid. In FIGS. 2a-2c, the liquid level is indicated by reference numerals 50, 52 and 54, respectively. As the liquid level changes from FIGS. 2a to 2b to 2c, the gaseous headspace volume is reduced, which reduces the surface area of liquid being introduced into the tank, thereby reducing the gas transfer efficiency into the liquid.

The liquid level within the tank can be controlled or adjusted in a variety of ways. For example, pumping mechanism 4 can be used to increase or decrease the amount of fluid being supplied to the tank, while maintaining the discharge flow from the tank at a constant rate. Alternately, the level within the tank can be adjusted by controlling the amount of liquid being discharged from the tank while maintaining the flow into the tank constant.

As noted above, the described method for adjusting the gas transfer efficiency through the adjustment of the liquid level within the tank may be programmed into a programmable logic controller or similar logic programming. Moreover, the method could be implemented in the form of two or more operation modes, differing in the level setpoint in the pressure vessel.

When using a typical pressure vessel design, which includes a cylindrical portion with end caps or heads which are hemispherical, optimum gas transfer efficiency usually occurs when the level is set between 30-50% of the tank seam to seam height. Minimal gas transfer efficiency would occur when the fluid level is set at the point in which the nozzle is completely submerged in the liquid. For gas transfer efficiencies between maximal and minimal, the level may be set anywhere between these two points. Those skilled in the art will readily appreciate that the inventive aspects of the present invention are not limited to the type of pressure vessel used as part of the dissolution tank.

Moreover, the mode of operation of the system may be toggled automatically using a dissolved gas probe or similar relay in the outlet flow of the liquid, such that, should the dissolved gas level in the outlet flow of liquid rise above or fall below the desired level, the level setpoint mode can change to accommodate the desired level of dissolved gas.

The present method improves diffusion efficiency of system 100 and permits almost instantaneous absorption of gas into the liquid to near saturation at the elevated pressure inside the dissolution tank. Droplets of liquid saturated with dissolved gas fall to the bottom of the dissolution tank to form a reservoir supply of treated liquid, which acts as a seal between the pressurized gas headspace and ambient pressure. In certain embodiments, the treated liquid supply is continuously injected into and mixed with a target liquid being treated at a controlled rate for a specific application. Liquid leaving the discharge device undergoes a large pressure (and energy) drop with the energy utilized for controlled mixing of the treatment liquid with the target liquid. Mixing can be controlled to produce target concentrations of dissolved gas in the bulk target liquid.

Liquid-liquid mixing rates control the delivery of dissolved gas over a range of concentrations as compared with previous delivery methods that entail control of gas-liquid mixing rates. Liquid-liquid mixing can enhance delivery efficiency and efficacy in a variety of applications. The discharge device can be arranged such that a supersaturated or hyperconcentrated liquid stream is rapidly mixed with the target liquid and liquid/liquid mixing occurs. The proper mixing ratio of supersaturated or hyperconcentrated liquid with bulk target liquid ensures that the dissolved gas remains in solution. Alternatively, the supersaturated or hyperconcentrated liquid stream can be introduced to the target liquid without mixing or with minimal mixing such that the excess gas leaves solution in the form of bubbles. The size of these bubbles can be controlled as desired for different applications. The only gas used in the previous invention is that which is dissolved into the liquid spray and exits the dissolution chamber resulting in no gas being used that is not dissolved into the fluid leaving the device and entering the target fluid. Furthermore, the present system is able to operate without use of gas recovery equipment. Preferred gases for use with the previous invention include, but are not limited to, oxygen, air, and ozone.

The present invention is an improvement over the prior art based on the ability to more precisely control the dissolved gas delivery. Whereas the prior art sought to maximize gas transfer efficiency, the present invention described here allows for a range of gas transfer efficiency from minimal to maximal. This allows the invention described herein to be used in a wider range of applications, particularly applications comprising a flow-through system where control of dissolved gas delivery and control of liquid flow are both paramount to the proper operation of the system. This is true since two parameters, both liquid flow and gas delivery, are now being controlled with the same system. This includes, but is not limited to, membrane bioreactors, sequencing batch reactors, water treatment systems, wastewater treatment systems, ecological remediation systems that require a range of dissolved gases in their processes. This range of dissolved gases includes, but is not limited to, oxygen, ozone, carbon dioxide, hydrogen, nitrogen, and air.

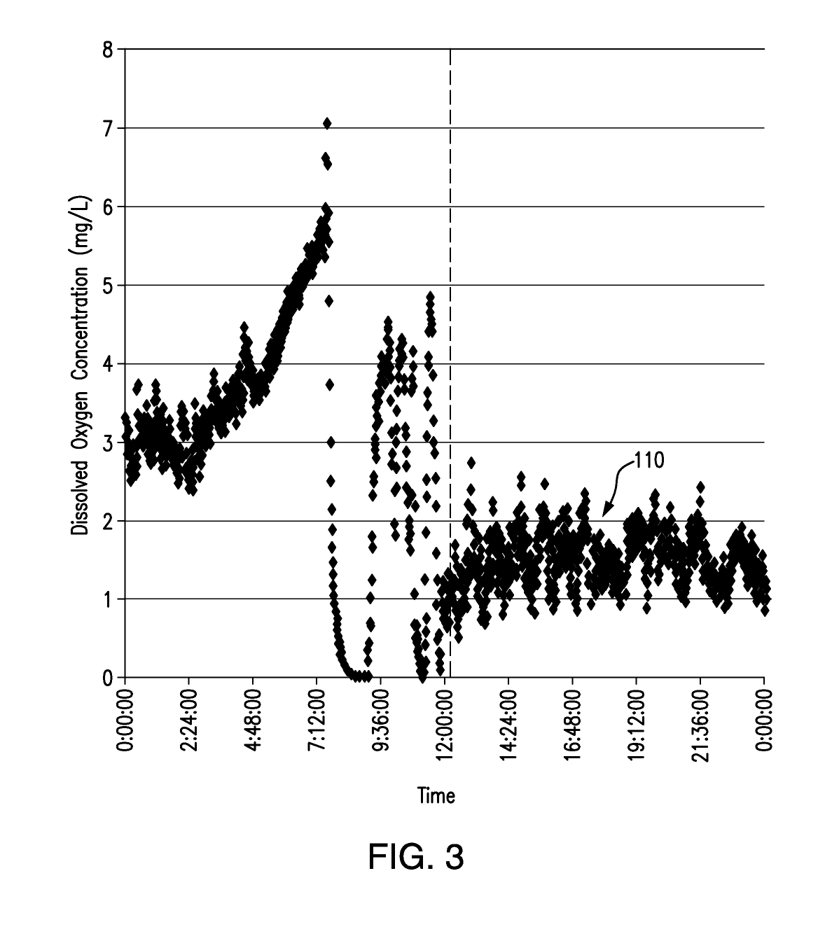

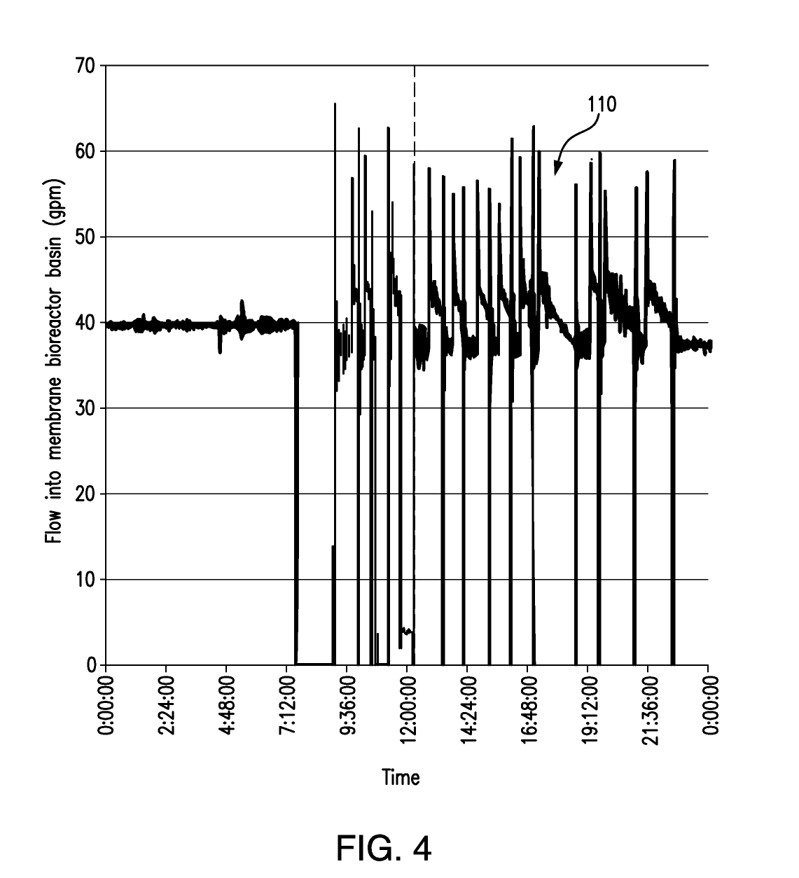

FIG. 3 provides a graphical representation to illustrate the precision control of dissolved oxygen delivery to a membrane bioreactor basin using the present invention. In the first part of FIG. 3, the fluid level within the dissolution tank is not varying, but the flow through the system is varying, and therefore, the oxygen delivery rate is in flux. Basically, the efficiency of the system is changing dramatically as the flow changes. The area identified by reference numeral 110 illustrates the control of the dissolved oxygen concentration over time in the membrane bioreactor basin as it operates to alternate between aerobic and anaerobic conditions (1 and 2 mg/L). FIG. 4 illustrates the varying flow into the present invention, as well as, the bioreactor basin during the same time period as in FIG. 3. The data is from an MBR operated by passing 100% of the bioreactor influent through the present invention prior to entry into the bioreactor. The sudden increase and decrease in flow indicated by the vertical lines shows how the present invention controlled the delivery rate of dissolved oxygen to the biological treatment basin of the MBR and thereby controlled the DO for nitrification and denitrification in a single basin. To reduce DO in the basin to produce anaerobic conditions, the liquid level in the dissolution tank was increased by suddenly increasing the flow rate into the tank via the pump by increasing the rotation speed of the pump electronically. As the liquid level increased in the tank, the gas headspace volume reduced such that their was no longer sufficient contact area between water spray and gas to allow saturation of the spray particles with gas thereby greatly reducing the rate of dissolved oxygen added to the biological treatment basin. The rapid oxygen uptake rate by the bacteria in the biological treatment basin coupled with no dissolved oxygen addition quickly lowered the DO to anaerobic conditions. When aerobic conditions were required, the water flow rate into the dissolution vessel was greatly reduced such that the liquid level in the tank dropped suddenly increasing the gas headspace to a volume sufficient to supersaturate the liquid spray thereby suddenly increasing the rate of dissolved oxygen added to the biological treatment basin to overcome the oxygen uptake rate of the bacteria to restore aerobic conditions.

While the subject invention has been described with respect to preferred embodiments, those skilled in the art will readily appreciate that changes and modifications may be made thereto without departing from the spirit and scope of the subject invention as defined by the appended claims.

What is claimed as new and desired to be protected by Letters Patent of the United States is:

1. A system for delivering a fluid having a desired dissolved gas concentration comprising:
(a) a dissolution tank including:
(i) a pressure vessel defining an internal chamber which contains a fluid and provides a regulated, pressurized gas head space above the fluid;
(ii) at least one liquid spray nozzle that permits passage of the fluid into the gas head space of the pressure vessel; and
(iii) an outlet for discharging the fluid having a desired gas concentration from the internal chamber of the pressure vessel;
(b) a gas source in communication with the gas head space of the pressure vessel;
(c) a pump for supplying the fluid to the spray nozzle of the dissolution tank such that fluid droplets are formed in the gas head space and the gas contained within the pressurized head space is dissolved into the fluid;
(d) a sensor or gauge for detecting the level of the fluid in the internal chamber of the pressure vessel;
(e) a controller for adjusting the level of fluid in the pressure vessel in order to achieve the desired dissolved gas concentration within the fluid.

2. A system as recited in claim 1, wherein the level of the fluid in the tank is detected using a liquid level gauge.

3. A system as recited in claim 1, further comprising a sensor for measuring the concentration of the gas within the fluid being discharged from the internal chamber of the pressure vessel.

4. A system as recited in claim 1, further comprising a second pump for discharging the fluid from the pressure vessel through the outlet at a constant flow rate.

5. A method for delivering a fluid having a desired dissolved gas concentration, comprising the steps of:
(a) providing a dissolution tank that includes:
(i) a pressure vessel defining an internal chamber which contains a fluid and provides a regulated, pressurized gas head space above the fluid;
(ii) at least one liquid spray nozzle that permits passage of the fluid into the gas head space of the pressure vessel; and
(iii) an outlet for discharging the fluid having a desired gas concentration from the interior chamber of the pressure vessel;
(b) providing a gas source in communication with the gas head space of the pressure vessel;
(c) supplying the fluid using a pumping to the spray nozzle of the dissolution tank such that fluid droplets are formed in the gas head space and the gas contained within the pressurized head space is dissolved into the fluid;
(e) detecting the level of the fluid in the internal chamber of the pressure vessel; and
(f) adjusting the level of fluid in the pressure vessel in order to achieve the desired dissolved gas concentration within the fluid.

6. A method of dissolving a gas in a liquid comprising the steps of:
a. Pressurizing an enclosed vessel with the gas; and
b. Spraying a first portion of the liquid containing dissolved gas from the vessel into a chamber that is provided with a plurality of orifices and which is immersed in a second portion of the liquid; and
c. Discharging the first liquid portion containing dissolved gas through the chamber orifices into the second liquid portion.

7. The method of claim 6, wherein the liquid level in the enclosed vessel is monitored with a liquid level gauge.

8. The method of claim 6, wherein the liquid level is transmitted to a programmable logic controller or similar logic programming.

9. The method of claim 8, wherein the liquid level operational setpoint is be maintained, adjusted, or otherwise controlled through the programmable logic controller or similar logic programming of claim 8.

10. The method of claim 6, wherein the gas enters the vessel is pressurized at least in part via a closed system injection of liquid until a desired higher pressure is attained therein.

11. The method of claim 6, wherein the pressurizing is conducted with a gas selected from the group consisting of air, oxygen, ozone, hydrogen, nitrogen, nitrous oxide, and carbon dioxide.

12. The method of claim 6, wherein the spraying is performed with a liquid that is primarily water.

13. The method of claim 6, wherein said spraying is performed until the first portion of liquid is dissolved with gas to 95% of saturation at the enclosed vessel pressure.

14. The method of claim 6, wherein the gas is separated on-site from ambient air prior to being pressurized into the vessel.

15. The method of claim 6, wherein said pressurizing is conducted with ozone gas.

16. The method of claim 6, wherein the gas is provided by on-site generation.

17. The method of claim 6, wherein the liquid is provided by a water tap located in a residence or industrial site and liquid is transferred into the vessel under tap pressure.

18. The method of claim 6, which is performed in continuous mode.

19. The method of claim 6, wherein the liquid is sprayed into the vessel under pressure provided by a high pressure liquid pump.

20. The method of claim 6, wherein fluid flow into the vessel from a high pressure pump is controlled via feedback from sensors indicating water capacity within the saturation tank.
